(19) United States
(12) Patent Application Publication
(10) Pub. No.: US 2012/0162795 A1
(43) Pub. Date: Jun. 28, 2012

(54) LENS BARREL, IMAGING DEVICE AND MOBILE TERMINAL DEVICE

(75) Inventor: Norihisa Yoshimura, Nara (JP)

(73) Assignee: Panasonic Corporation, Osaka (JP)

(21) Appl. No.: 13/391,869

(22) PCT Filed: Jun. 6, 2011
(86) PCT No.: PCT/JP2011/003166

§ 371 Date: Feb. 23, 2012

(30) Foreign Application Priority Data
Jun. 16, 2010 (JP) 2010-136971

(51) Int. Cl. G02B 7/02

(52) U.S. Cl. 359/830; 359/819

(57) ABSTRACT

A lens barrel includes: a lens holder; and an imaging lens that includes a plurality of lenses inserted in the lens holder, the plurality being at least three, wherein a resin spacer having elasticity in an optical axis direction is disposed between the lenses that affect field curvature, and the resin spacer is deformed and fixed in position by compressing a space between the lenses that affect the field curvature. Accordingly, the space between the lenses that tend to affect the field curvature is compressed to elastically deform the resin spacer in an optical axis direction, to thereby make it possible to adjust an interval between the lenses. Consequently, it is possible to correct the field curvature, to thereby prevent lowering of resolution.

### TECHNICAL FIELD

The present invention relates to configurations of a lens barrel, an imaging device, a mobile terminal device, and the like.

### BACKGROUND ART

In recent years, in a lens barrel that is mounted in a mobile terminal device such as a mobile phone or a portable information terminal having a camera, in order to reduce the size of a mounting space, a small-sized lens barrel or the like has been demanded. Further, in order to cope with a large-sized image pickup device or highly fine pixels, an imaging lens having high resolution has been demanded.

A lens barrel in the related art includes a lens unit that includes a plurality of lenses that is inserted in a lens holder, a spacer that is disposed between the respective lenses, a pressing section that is disposed in the lens holder and presses a lens on one end side in an optical axis direction to the other end side, and a lens pressing member that presses a lens on the other side in the optical axis direction to the one end side in the optical axis direction to fix the respective lenses and the spacer to the lens barrel. Further, the lens unit includes a backlash preventing member that is disposed between the pressing section and the lenses or between the lens pressing member and the lenses. Here, the lens holder and the spacer are formed of aluminum or brass (for example, PTL 1). Thus, the reduction in optical performance due to environmental changes is suppressed.

However, in an imaging device that employs a lens barrel disclosed in PTL 1, due to thickness unevenness caused by individual differences of the spacer and the lenses, a gap between the lenses that tend to affect field curvature in particular varies. Thus, the field curvature occurs, and thus, the resolution of the imaging lens is lowered.

### CITATION LIST

### Patent Literature

PTL 1 Japanese Patent Unexamined Publication No. 2008-304642

### SUMMARY OF THE INVENTION

According to an embodiment of the present invention, there is provided a lens barrel including: a lens holder; and an imaging lens that includes a plurality of lenses inserted in the lens holder, the plurality being at least three, wherein a resin spacer having elasticity in an optical axis direction is disposed between the lenses that affect field curvature, and the resin spacer is deformed and fixed in position by compressing a space between the lenses that affect the field curvature.

According to such a configuration, the space between the lenses that tend to affect the field curvature is compressed to elastically deform the resin spacer in an optical axis direction, to thereby make it possible to adjust an interval between the lenses. Consequently, it is possible to correct the field curvature, to thereby prevent lowering of resolution.

### BRIEF DESCRIPTION OF DRAWINGS

FIG. 1 is a side sectional view illustrating a lens barrel and an imaging device according to an exemplary embodiment of the present invention.

FIG. 2 is a partially enlarged cross-sectional view illustrating a configuration around a resin spacer of a lens barrel according to the exemplary embodiment of the present invention.

FIG. 3 is a partially enlarged cross-sectional view illustrating a lens retaining section of a lens holder of a lens barrel according to the exemplary embodiment of the present invention.

FIG. 4 is a plan cross-sectional view illustrating positions of a second adhesive agent and a third adhesive agent of an imaging device according to the exemplary embodiment of the present invention.

FIG. 5A is a partially enlarged cross-sectional view illustrating an example of a bonding state by the third adhesive agent according to the exemplary embodiment of the present invention.

FIG. 5B is a partially enlarged cross-sectional view illustrating another example of a bonding state by the third adhesive agent.

FIG. 5C is a partially enlarged cross-sectional view illustrating still another example of a bonding state by the third adhesive agent.

FIG. 6A is a plan view illustrating a mobile terminal device according to the exemplary embodiment of the present invention.

FIG. 6B is a plan view of the mobile terminal device in FIG. 6A when seen from a rear surface.

### DESCRIPTION OF EMBODIMENTS

Hereinafter, a lens barrel, an imaging device, and a mobile terminal device according to exemplary embodiments of the present invention will be sequentially described with reference to the accompanying drawings. The present invention is not limited to this exemplary embodiment.

### Exemplary Embodiment

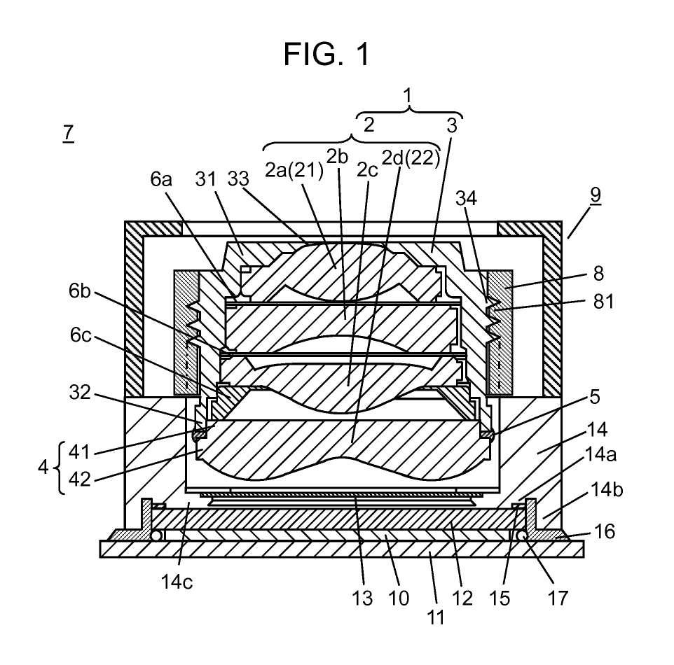

FIG. 1 is a side sectional view illustrating lens barrel 1 and imaging device 7 according to an exemplary embodiment of the present invention.

As shown in FIG. 1, lens barrel 1 at least includes imaging lens 2, lens holder 3, and resin spacer 6c. Imaging lens 2 includes a plurality of lenses of three or more. In the present embodiment, an example in which imaging lens 2 includes four lenses 2a to 2d will be described. Lens holder 3 accommodates imaging lens 2 inserted therein. Resin spacer 6c has elasticity in an optical axis direction, and is disposed between the lenses of imaging lens 2 (in the present embodiment, between lens 2c and lens 2d) that tend to affect field curvature. Further, lens barrel 1 is positioned and fixed by an adhesive agent, for example, in a state where a space between the lenses that tend to affect the field curvature is compressed to deform resin spacer 6c.

The field curvature refers to an aberration in which a focus surface is curved. Further, the space between the lenses that tend to affect the field curvature refers to a lens space in which the relationship of image inclination level [μm]/lens interval [μm] is, for example, a value of 0.6 [μm]/lens interval [μm] or higher, or preferably a value of 1 [μm]/lens interval [μm] or higher.

Hereinafter, a specific configuration of lens barrel 1 will be described in detail.

As shown in FIG. 1, imaging lens 2 of lens barrel 1 includes four lenses 2a to 2d having edge portions (for example, portions that surfaces perpendicular to the optical axis direction are flat surface shapes) in their outer peripheral portions, which are sequentially arranged toward the image pickup device 10 from the side of an object. The side of lens 2a corresponds to the side of the object, and the side of lens 2d corresponds to the side of image pickup device 10. Further, light shielding spacers 6a and 6b that are light shielding plates and resin spacer 6c that is a light shielding plate and has elasticity in the optical axis direction are disposed between respective lenses 2a to 2d of imaging lens 2. Further, lens barrel 1 has the tubular lens holder 3 that holds imaging lens 2, light shielding spacers 6a and 6b and resin spacer 6c in an inner wall.

Here, resin spacer 6c is formed of a material such as polycarbonate (PC), polyethylene terephthalate (PET), polybuthyl terephthalate (PBT), polyamide (PA) or polyacetal (POM), for example. At this time, the bending elastic modulus of resin spacer 6c is preferably 2000 MPa to 3000 MPa. For example, the interval between lenses 2c and 2d is constantly maintained by the bending elastic modulus, to thereby obtain an imaging lens having high resolution. This is because that in a case where the bending elastic modulus is less than 2000 MPa that is excessively small, the lens is inclined or the lens interval is changed by vibration or shock. On the other hand, in a case where the bending elastic modulus exceeds 3000 MPa that is excessively large, it is difficult to adjust the lens interval. Consequently, if the bending elastic modulus is less than 2000 MPa or exceeds 3000 MPa, the resolution of imaging lens 2 is lowered.

Hereinafter, the resin spacer according to the present embodiment will be described with reference to the accompanying drawings.

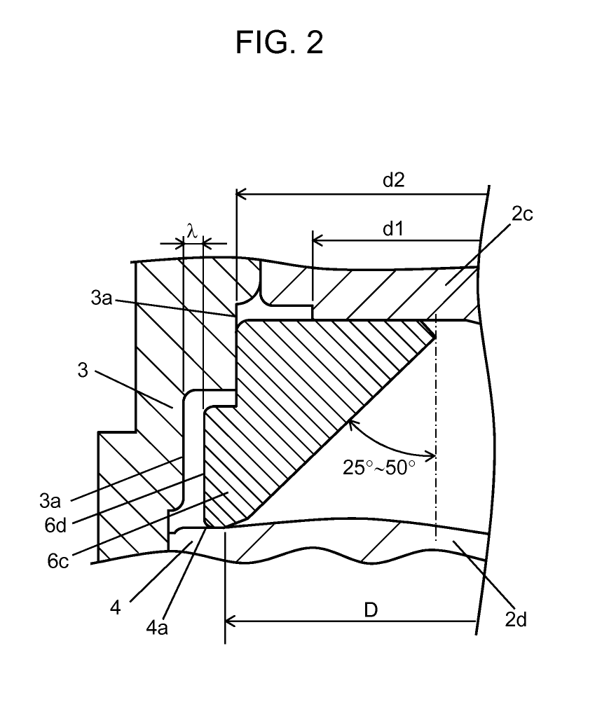

FIG. 2 is a partially enlarged cross-sectional view illustrating a configuration around the resin spacer of the lens barrel according to the exemplary embodiment of the present invention.

As shown in FIG. 2, resin spacer 6c is formed in a ring form having a taper-shaped portion in which the inner wall diameter thereof on the side of the image pickup device is larger than that on the side of the object. Further, the inclination angle of the taper-shaped portion is formed at 25 degrees to 50 degrees with respect to the optical axis. Thus, reflection of incident light on a taper surface of the taper-shaped portion is suppressed to prevent generation of ghost. Further, by forming the taper-shaped portion in resin spacer 6c, for example, it is possible to easily adjust the interval between lenses 2c and 2d that tend to affect the field curvature. In a case where the inclination angle of the taper-shaped portion is less than 25 degrees that is excessively small, resin spacer 6c may be divided at the time of being pressed. On the other hand, in a case where the inclination angle exceeds 50 degrees that is excessively large, it is difficult to set the thickness of resin spacer 6c to a regulated thickness or more, and thus, a design margin for the thickness of resin spacer 6c becomes small. Thus, by setting the inclination angle of the taper-shaped portion to 25 degrees to 50 degrees with respect to the optical axis, it is possible to obtain resin spacer 6c that has superior reliability and achieves an easy design.

Further, as shown in FIG. 2, outer peripheral end portion 6d of resin spacer 6c on the side of the image pickup device is in contact with flat surface portion 4a of outer peripheral end portion 4 of lens 2d, and a gap λ is formed between inner wall 3a of lens holder 3 and outer peripheral end portion 6d. Here, the gap λ is preferably 50 μm or more, more preferably in the range of 100 μm to 500 μm. That is, when the gap λ is less than 50 μm that is excessively small, outer peripheral end portion 6d of resin spacer 6c is easily in contact with the surface of inner wall 3a of lens holder 3, and it is thus difficult to adjust the interval between the lenses. On the other hand, when the gap λ is excessively large, in a case where the external dimensions of lens holder 3 are uniform, the thickness of a tubular portion of lens holder 3 becomes thin, and thus, the mechanical strength of lens holder 3 is reduced. On the other hand, if the external dimensions of lens holder 3 are increased in order to maintain the strength of lens holder 3, a problem arises that lens barrel 1 becomes large. Thus, by setting the gap λ to a predetermined value or more, it is possible to maintain the mechanical strength of resin spacer 6c, and by setting the gap λ in the range of predetermined values, it is possible to prevent the lens barrel or the like from becoming large.

Further, as shown in FIG. 2, a minimum diameter D of resin spacer 6c in a portion that is in contact with lens 2d on the side of image pickup device 10 shown in FIG. 1 is formed to be larger than a maximum diameter d1 thereof in a portion that is in contact with lens 2c on the side of the object or a maximum diameter d2 thereof in a portion that is in contact with the surface of inner wall 3a of lens holder 3. Thus, when resin spacer 6c is pressed between lens 2d on the side of the image pickup device and lens 2c on the side of the object, for example, it is possible to deform outer peripheral end portion 6d of resin spacer 6c in the radial direction, and to deform resin spacer 6c in the optical axis direction. As a result, for example, it is possible to easily adjust the interval between lenses 2c and 2d. Further, since it is not necessary to press resin spacer 6c with excessive (excessively large) pressure, it is possible to enhance durability of resin spacer 6c.

In the present embodiment, as shown in FIG. 1, an example in which the surfaces of lenses 2a to 2d with light shielding spacers 6a and 6b or resin spacer 6c having elasticity being interposed therebetween are formed as flat surfaces is shown, but the present invention is not limited thereto. For example, the surfaces may be formed as convex surfaces or curved surfaces. By setting the surface of lens 2d on the side of the object as a curved surface, resin spacer 6c is easily elastically deformed in the radial direction along the curved surface, and it is thus easy to adjust the interval between the lenses. At this time, the material of resin spacer 6c that adjusts the interval between the lenses is preferably a polyamide (PA) material having a small friction coefficient.

Further, imaging lens 2 according to the present embodiment includes a plurality of, for example, four concave lenses and convex lenses, and the external dimension (diameter) or shape of each lens is different. Specifically, as shown in FIG. 1, in lens 2d that is positioned close to the imaging surface (image pickup device 10), the size (external dimension) becomes large. Thus, the size of lens 2a that is positioned in the furthest from the imaging surface (hereinafter, referred to as front lens 21) becomes the smallest, and the size of lens 2d (hereinafter, referred to as rear lens 22) that is positioned in the closest to the imaging surface becomes the largest.

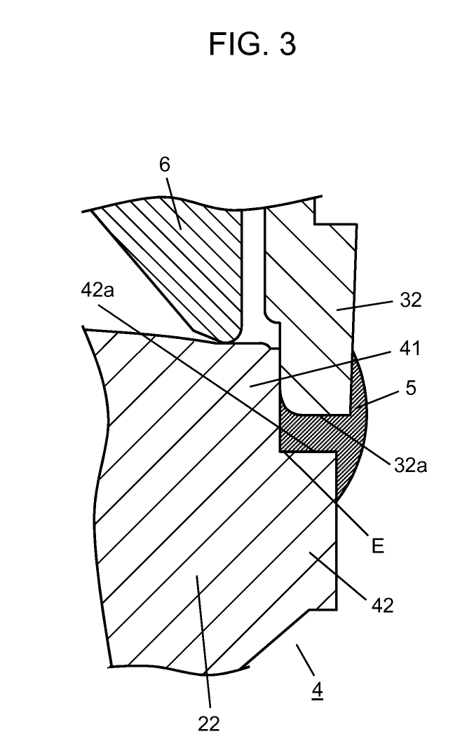

Further, as shown in FIG. 1 (or FIG. 3), barrel inserting section 41 and lens pressing section 42 are provided in outer peripheral end portion 4 of rear lens 22, and the outer diameter of outer peripheral end portion 4 of rear lens 22 is smaller than the outer diameter of lens retaining section 32. Here, barrel inserting section 41 is formed to be smaller than the inner diameter of lens retaining section 32 of lens holder 3 that will be described later. Further, lens pressing section 42 is extended from barrel inserting section 41 and is formed to be larger than the inner diameter of lens retaining section 32. Further, lens pressing section 42 is spaced from end surface 32a (end surface on the side of image pickup device 10 in lens holder 3) of lens retaining section 32 of lens holder 3, and has opposite surface 42a positioned in an opposite position.

In the present embodiment, a part of the outer peripheral end portion of imaging lens 2 (except for rear lens 22) is cut (D cut or notch) on account of lens processing, forming or the like, for example.

Further, as shown in FIG. 1, lens holder 3 is configured to accommodate imaging lens 2 that includes the plurality of (four in the present embodiment) lenses 2a to 2d, light shielding spacers 6a and 6b and resin spacer 6c having elasticity that are disposed between lenses 2a to 2d. Here, lens supporting section 31 that entirely or partially supports outer peripheral end portion of one surface side (object side) of front lens 21 of imaging lens 2 in the optical axis direction is formed on one end portion (end portion of the object side) of lens holder 3. Further, lens retaining section 32 that entirely or partially faces the outer peripheral end portion of the other surface side (imaging surface side) of rear lens 22 of imaging lens 2 is formed on the other end portion (end portion of the imaging surface side) of lens holder 3.

Hereinafter, lens retaining section 32 of the above-described lens holder 3 will be described with reference to FIG. 3.

FIG. 3 is a partially enlarged cross-sectional view illustrating a lens retaining section of a lens holder of a lens barrel according to an exemplary embodiment of the present invention.

As shown in FIG. 3, an outer peripheral surface of a tip end portion of lens retaining section 32 of lens holder 3 is formed in a taper shape in which its diameter becomes small as it goes to the tip end side. On the other hand, an inner peripheral surface of the tip end portion of lens retaining section 32 of lens holder 3 is formed in an R shape, for example, in which its diameter becomes large as it goes to the tip end side.

Further, a plurality of slits (not shown), holes, concaves and convexes or the like are formed on the entire surface of the outer peripheral surface of the tip end portion of lens retaining section 32 of the taper shape in a discrete manner or a predetermined interval.

Further, as shown in FIG. 1, opening section 33 that serves as a stop (aperture) of imaging lens 2 is disposed on an upper part (object side) of lens holder 3.

Further, male screw 34 that is to be screwed with holder 8 (which will be described later) is formed on an outer surface of lens holder 3.

Further, as described above, lens barrel 1 is configured by accommodating imaging lens 2, light shielding spacers 6a and 6b and resin spacer 6c from lens supporting section 31 of lens holder 3 toward lens retaining section 32. Here, as shown in the right half portion of FIG. 1, a gap (space) is formed in a part between the outer peripheral end portion of imaging lens 2 (except for rear lens 22) and the inner peripheral surface of lens holder 3 by the cut portion formed on the outer peripheral end portion (edge portion) of imaging lens 2 (except for rear lens 22). Further, light shielding spacers 6a and 6b and resin spacer 6c are installed between the outer peripheral end portions of respective lenses 2a to 2d, but are not cut according to the cut (D cut or notch) of lenses 2a to 2d. Further, among the plurality of lenses 2a to 2d of the accommodated imaging lens 2, an upper surface of the outer peripheral end portion of front lens 21 (lens 2a) that is positioned closest to opening section 33 of lens holder 3 is in contact with a lower surface of lens supporting section 31 of lens holder 3, and an outer front surface of the central portion except for the outer peripheral end portion of front lens 21 is accommodated while maintaining a predetermined distance that exceeds 0 μm and 50 μm or less, for example, from the lower surface of lens holder 3. Further, barrel inserting section 41 of rear lens 22 (lens 2d) that is positioned closest to the imaging surface is inserted in lens retaining section 32 of lens holder 3, and rear lens 22 is installed to lens holder 3. Here, in a state where rear lens 22 is inserted in lens holder 3, opposite surface 42a of lens pressing section 42 of rear lens 22 that is extended from barrel inserting section 41 and is larger than the inner diameter of lens retaining section 32 is in a spaced position where opposite surface 42a is opposite to end surface 32a of lens retaining section 32. Thus, a groove portion is formed by the tip end portion of lens holder 3 and the outer peripheral end portion of rear lens 22 that are spaced from each other. That is, the groove portion is formed in a concave shape and an annular shape by lens retaining section 32 of lens holder 3, and barrel inserting section 41 and lens pressing section 42 of rear lens 22. Further, a predetermined adhesive agent (hereinafter, referred to as a first adhesive agent) 5 fills the groove portion to thereby bond and fix end surface 32a of lens retaining section 32 of lens holder 3 and opposite surface 42a of lens pressing section 42 of rear lens 22 by first adhesive agent 5. Here, as first adhesive agent 5, for example, an adhesive agent of a thermoset type or an ultraviolet curing type having a main component of acrylic resin or epoxy resin is used, and preferably, the adhesive agent of the ultraviolet curing type or the like is used.

As shown in FIG. 3, in order to reduce the height of the lens barrel, a corner portion E formed by barrel inserting section 41 of rear lens 22 and opposite surface 42a of lens pressing section 42 is disposed in a position that is not in contact with the lens optical path of imaging light beams (maximum image height). Thus, the light beams of the imaging light beams (maximum image height) do not pass the corner portion E, and thus, imaging of the light beams due to dispersion or the like in the corner portion E is not hindered.

Hereinafter, a manufacturing method of lens barrel 1 having the above-described configuration will be described in detail with reference to FIG. 1.

Firstly, as shown in FIG. 1, front lens 21 of imaging lens 2, light shielding spacer 6a, lens 2b, light shielding spacer 6b and resin spacer 6c that has elasticity and rear lens 22 are sequentially inserted toward opening section 33 of lens holder 3, respectively. Here, the inner wall diameter of lens holder 3, and the outer peripheral diameters of lenses 2a to 2d of imaging lens 2 and the diameter of the outer peripheral end portion of resin spacer 6c on the object side are fitted to each other by clearance fit. Further, the upper surface of the outer peripheral end portion of front lens 21 that is positioned closest to the opening section of lens holder 3 is in contact with the lower surface of lens supporting section 31 of lens holder 3, and the outer front surface of the central portion except for the outer peripheral end portion of front lens 21 is accommodated in lens holder 3 while maintaining a distance of about 20 μm, for example, from the lower surface of lens holder 3.

Next, lens pressing section 42 of rear lens 22 that is positioned closest to the imaging surface is pressed in the optical axis direction from the side of rear lens 22 to thereby insert barrel inserting section 41 of rear lens 22 into lens retaining section 32. Further, by pressing and inserting rear lens 22, resin spacer 6c having elasticity is elastically deformed, and lens holder 3 and rear lens 22 are bonded and fixed to each other by the first adhesive agent in a position where field curvature is suppressed. At this time, lens pressing section 42 of rear lens 22 is mechanically pressed using a light shielding spacer, jig or the like, for example, so that the spaced distance between end surface 32a of lens retaining section 32 and opposite surface 42a of lens pressing section 42 is, for example, 30 μm or more and 1 mm or less, and more preferably 50 μm or more and 500 μm or less. Further, first adhesive agent 5 is inserted in the portion where end surface 32a of lens retaining section 32 is spaced from lens pressing section 42. Thus, among end surface 32a of lens retaining section 32, opposite surface 42a of lens pressing section 42 and barrel inserting section 41, the side surface of the portion that is not inserted in lens retaining section 32 is bonded and fixed by first adhesive agent 5. Here, in a case where the amount of first adhesive agent 5 is large, first adhesive agent 5 reaches the outside of the outer peripheral surface of the tip end portion of lens retaining section 32 to increase the bonding area. Further, in a case where the amount of first adhesive agent 5 is small, the shape of first adhesive agent 5 at opposite ends in the spaced portion is formed in a fillet shape. Thus, even in a case where the amount of first adhesive agent 5 is large or small, at least end surface 32a of lens retaining section 32 and opposite surface 42a of lens pressing section 42 are bonded and fixed to each other by first adhesive agent 5.

Further, in a state where rear lens 22 is inserted in lens holder 3, first adhesive agent 5 is disposed in the groove portion between end surface 32a of lens retaining section 32 and opposite surface 42a of lens pressing section 42 for bonding and fixing. Thus, it is possible to suppress first adhesive agent 5 from entering the inner side (side where the lenses other than rear lens 22 are accommodated) of lens holder 3 in which rear lens 22 is inserted. As a result, it is possible to prevent first adhesive agent 5 from being attached to the front surface (surface through which incident light passes) of rear lens 22.

Hereinafter, the imaging device including the lens barrel according to the present embodiment will be described with reference to FIG. 1.

As shown in FIG. 1, imaging device 7 includes lens barrel 1 (imaging lens 2 and lens holder 3) of the present embodiment, casing 9, image pickup device 10, substrate 11 on which image pickup device 10 is mounted, glass plate 12 that covers image pickup device 10, and infrared light cut filter 13. Further, casing 9 includes the tubular holder 8 that accommodates imaging lens 2 through lens holder 3. Image pickup device 10 is disposed in a position that is spaced by a predetermined distance from rear lens 22, and has a light receiving section in a central portion thereof.

Further, casing 9 includes holder 8 that holds lens holder 3, and supporting section 14 that is disposed on the side of holder 8 and supports holder 8. Holder 8 is a tubular shape where female screw 81 is formed in an inner surface thereof and is fixed to lens holder 3 by screwing female screw 81 with male screw 34 of lens holder 3.

Further, positioning section 14a and protruding section 14b are formed in a lower part of supporting section 14. Positioning section 14a of supporting section 14 mainly performs up and down positioning of lens holder 3 and imaging lens 2 that are held in holder 8. Protruding section 14b of supporting section 14 is disposed to protrude toward image pickup device 10 (or substrate 11) (downward).

Further, positioning section 14a of supporting section 14 is a flat surface shape having a predetermined area and has an outer periphery of a rectangular shape when seen from a planar view. Here, imaging lens 2 is positioned with respect to image pickup device 10 by positioning section 14a of supporting section 14, in the vicinity of outer peripheral end portion of image pickup device 10 with reference to the light receiving section of image pickup device 10. Specifically, positioning section 14a of supporting section 14 is in contact with the front surface (upper surface) of glass plate 12 that is positioned on the upper side of image pickup device 10, and positioning section 14a of supporting section 14 and glass plate 12 are bonded and fixed to each other by a predetermined adhesive agent (hereinafter, referred to as a second adhesive agent) 15. As second adhesive agent 15, for example, an adhesive agent of a thermoset type or an ultraviolet curing type having a main component of acrylic resin or epoxy resin is used, and preferably, the epoxy adhesive agent of the thermoset curing type or the like is used.

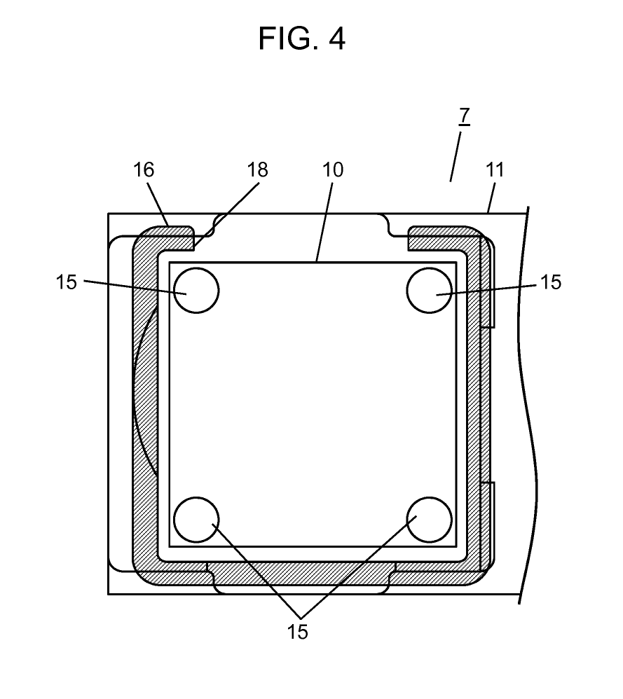

Here, an arrangement of the adhesive agent applied in a case where imaging device 7 is formed will be described with reference to FIG. 4 and FIG. 1.

FIG. 4 is a plan cross-sectional view illustrating positions of the second adhesive agent and third adhesive agent of the imaging device according to the exemplary embodiment of the present invention.

As shown in FIG. 4, second adhesive agent 15 is applied in positions of a lower surface of supporting section 14, for example, in positions in the vicinity of four corner portions, and bonds and fixes supporting section 14 disposed on the side of holder 8 shown in FIG. 1 and glass plate 12 mounted on substrate 11.

Further, protruding section 14b of supporting section 14 is disposed to protrude toward substrate 11 to cover the outer periphery of image pickup device 10, in a position outside the outer peripheral edge of image pickup device 10. Specifically, a lower surface of protruding section 14b of supporting section 14 is formed in a rectangular shape (rectangular tube shape) and is formed to protrude toward substrate 11 in the position outside the outer peripheral edge of glass plate 12.

Further, as shown in FIG. 4, protruding section 14b of supporting section 14 is fixed to the front surface (upper surface) of substrate 11 by a predetermined adhesive agent (hereinafter, referred to as third adhesive agent) 16. In the present embodiment, as third adhesive agent 16, for example, an adhesive agent such as silicone resin, allyl ester, acrylic resin, epoxy resin, polyimide or urethane resin is used, and preferably, an elastic adhesive agent of a silicone modified polymer system, or the like is used.

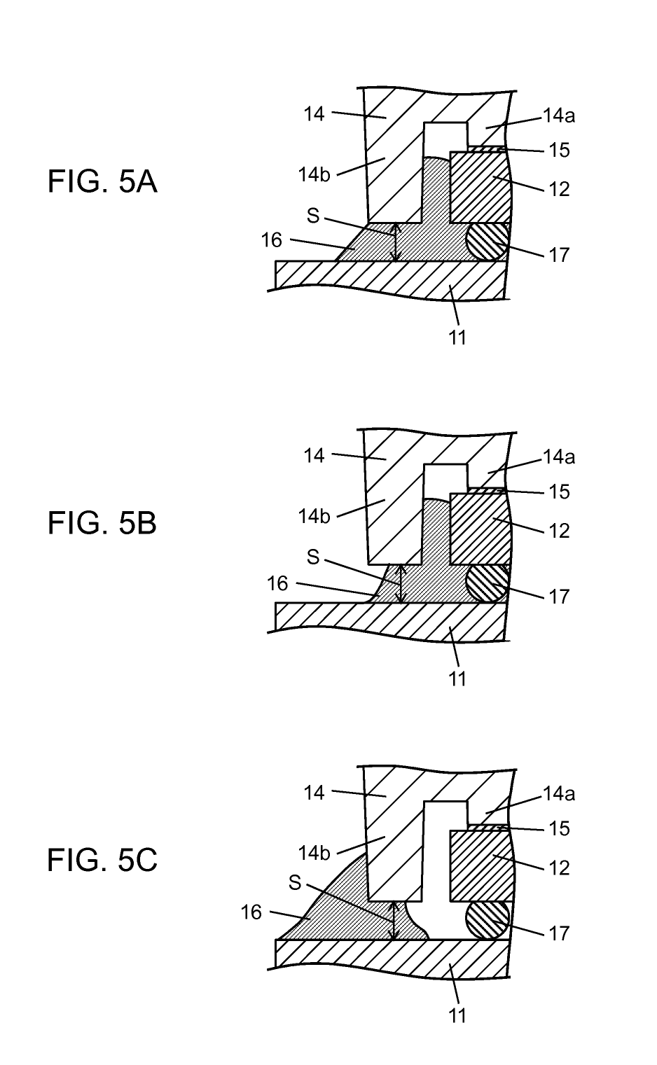

Hereinafter, in the imaging device of the present embodiment, a method of bonding and fixing substrate 11 and supporting section 14 will be described with reference to FIG. 5A.

FIG. 5A is a partially enlarged cross-sectional view illustrating an example of a bonding state by the third adhesive agent according to an exemplary embodiment of the present invention.

As shown in FIG. 5A, protruding section 14b of supporting section 14 is disposed being distant from the front surface of substrate 11 at a predetermined interval S, and is not directly in contact with the front surface of substrate 11. In the present embodiment, the interval S between the tip end of protruding section 14b and the front surface of substrate 11 is set in the range of 0.1 mm to 0.5 mm, for example, and preferably, in the range of 0.2 mm to 0.3 mm. Further, protruding section 14b and substrate 11 are bonded and fixed to each other by third adhesive agent 16 that is interposed between protruding section 14b of supporting section 14 and the substrate 11. In a case where the interval S exceeds 0.5 mm, since third adhesive agent 16 is expanded toward an outer peripheral surface of substrate 11, it is necessary to increase the external dimension of substrate 11. On the other hand, in a case where the interval S is smaller than 0.1 mm, since it is difficult for third adhesive agent 16 to be disposed in the interval S and the bonding area is decreased, the bonding strength is lowered, and thus, substrate 11 may be misaligned, for example. Thus, it is preferable that the interval S be set in the above-described range.

Further, as shown in FIG. 5A, protruding section 14b of supporting section 14 intrudes into the upper side of third adhesive agent 16 applied on substrate 11, substrate 11 and protruding section 14b are fixed to each other as third adhesive agent 16 is cured. Specifically, the thickness of third adhesive agent 16 before bonding, that is applied with a predetermined thickness, is applied to be thicker than the spaced interval S between protruding section 14b and the front surface of substrate 11, when positioning section 14a is in contact with glass plate 12 on which image pickup device 10 is disposed. Thus, when positioning section 14a of supporting section 14 is in contact with glass plate 12 on which image pickup device 10 is disposed, protruding section 14b of supporting section 14 intrudes into the top of third adhesive agent 16. Here, the term “intrude” that protruding section 14b intrudes into third adhesive agent 16 means that the tip end of protruding section 14b moves downward (side of substrate 11) from the top portion of third adhesive agent 16 of the predetermined thickness applied on substrate 11, as shown in FIG. 5A.

In FIG. 5A, an example in which a part of the tip end of protruding section 14b of supporting section 14 intrudes into third adhesive agent 16 is described, but the present invention is not limited thereto. Hereinafter, as described with reference to FIGS. 5B and 5C, for example, the bonding and fixing may be carried out in a state where the entire or another part of the tip end portion of protruding section 14b intrudes into third adhesive agent 16.

FIG. 5B is a partially enlarged cross-sectional view illustrating another example of a bonding state by the third adhesive agent. FIG. 5C is a partially enlarged cross-sectional view illustrating still another example of a bonding state by the third adhesive agent.

Firstly, as shown in FIG. 5B, a portion of protruding section 14b of supporting section 14 on the side of glass plate 12 on which image pickup device 10 is disposed may intrude into third adhesive agent 16. Further, as shown in FIG. 5C, a portion of an outer peripheral side (side opposite to the side of glass plate 12 on which image pickup device 10 is disposed) of protruding section 14b of supporting section 14 may intrude into third adhesive agent 16. Here, the viscosity of third adhesive agent 16 is set to be higher than second adhesive agent 15, and the thickness of third adhesive agent 16 is set to be thicker than the thickness of second adhesive agent 15. Specifically, in a case where the interval between the tip end of protruding section 14b of supporting section 14 and the front surface of substrate 11 is 0.2 mm, the thickness of third adhesive agent 16 is set to 0.3 mm that exceeds at least 0.2 mm, and the thickness of second adhesive agent 15 is set to 0.01 mm that is smaller than 0.2 mm of the thickness of third adhesive agent 16. The thickness (height) of third adhesive agent 16 is preferably set to be lower than that of the upper surface of glass plate 12 so that third adhesive agent 16 is not scattered and attached to the imaging area of image pickup device 10, in a state where protruding section 14b of supporting section 14 and substrate 11 are fixed to each other.

Further, as shown in FIG. 4, third adhesive agent 16 is applied on substrate 11 to cover (surround) the outer peripheral surface of image pickup device 10. That is, image pickup device 10 and glass plate 12 are formed in a rectangular shape when seen from a planar view, and third adhesive agent 16 is applied on substrate 11 so as to consecutively surround respective sides of the rectangular glass plate 12, on which image pickup device 10 is disposed, in a rectangular shape. Here, third adhesive agent 16 is applied on substrate 11 while remaining a gap in a part of glass plate 12 without completely surrounding glass plate 12 on which image pickup device 10 is disposed. Communicating section 18 that connects the inside of third adhesive agent 16 (region of the side of glass plate 12 on which image pickup device 10 is disposed) and the outside thereof (region opposite to the side of glass plate 12 on which image pickup device 10 is disposed) is formed by the gap portion. It is possible to discharge heat generated in a region in the vicinity of image pickup device 10 inside third adhesive agent 16 or air expanded by heat to the outside, by communicating section 18.

Further, as shown in FIG. 1, by interposing a part of third adhesive agent 16 having high viscosity between protruding section 14b of supporting section 14 that is disposed on the side of holder 8 and glass plate 12, it is possible to effectively prevent misalignment of holder 8.

Further, image pickup device 10 is bonded and fixed onto the lower side of glass plate 12 and the lower surface of glass plate 12 is fixed to substrate 11 through connecting section 17.

Further, infrared light cut filter 13 is fixed to supporting section 14 disposed on the side of holder 8 in a position between rear lens 22 and glass plate 12. Here, infrared light cut filter 13 is fixed to supporting section 14 in an inner position with reference to lower part 14c of supporting section 14.

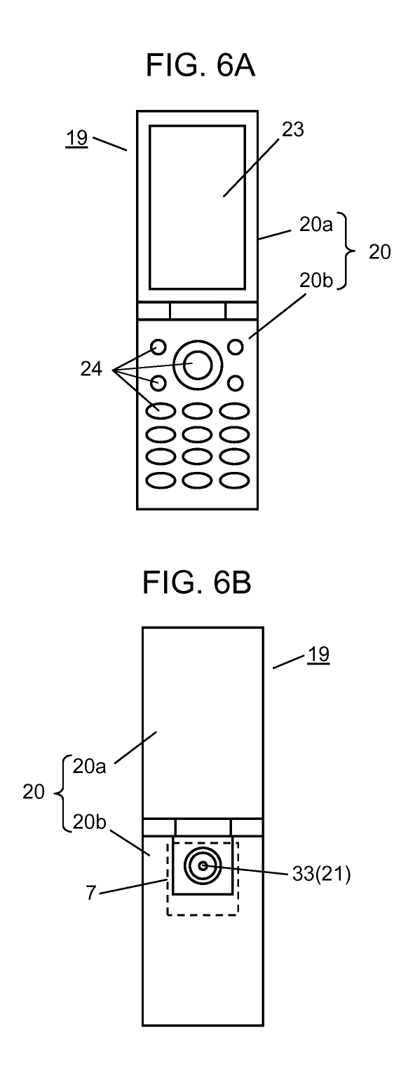

Hereinafter, mobile terminal device 19 having the above-described imaging device 7 will be described with reference to FIGS. 6A and 6B. As mobile terminal device 19, a mobile phone with a camera will be described as an example.

FIG. 6A is a plan view illustrating a mobile terminal device according to an exemplary embodiment of the present invention. FIG. 6B is a plan view of the mobile terminal device in FIG. 6A when seen from a rear surface.

As shown in FIGS. 6A and 6B, mobile terminal device 19 of the present embodiment includes at least main case 20, display 23 mounted on main case 20, operating section 24, and imaging device 7.

Main case 20 includes two rectangular plate bodies 20a and 20b of a folding type, for example, and respective short sides of plate bodies 20a and 20b are connected by a connecting section of a hinge shape, for example. Further, plate bodies 20a and 20b are configured to be folded in one direction so that a surface of one plate body 20a faces a surface the other plate body 20b in the connecting section. Further, as shown in FIG. 6A, display 23 is arranged on the inner surface of one plate body 20a of main case 20, and operating section 24 is arranged on the inner surface of the other plate body 20b. Further, main case 20 is folded so that the surface where display 23 is arranged and the surface where operating section 24 is arranged closely face each other. Display 23 is a liquid crystal display panel or the like of a rectangular shape, for example, and displays information relating to an operation of the mobile phone. Operating section 24 includes circular and elliptical buttons, and the mobile phone is operated by pressing the buttons. Imaging device 7 has the above-described configuration, and as shown in FIG. 6B, and is provided in main case 20 in a state where opening section 33 (front lens 21) of lens holder 3 is arranged on the surface of main case 20 opposite to the surface where operating section 24 is arranged.

As described above, according to lens barrel 1, imaging device 7 and mobile terminal device 19 in the present embodiment, lens barrel 1 includes barrel inserting section 41 having the external diameter that is the same as or smaller than the inner diameter of lens retaining section 32 in outer peripheral end portion 4 of rear lens 22 that is positioned closest to the imaging surface. Thus, barrel inserting section 41 of rear lens 22 is inserted in lens retaining section 32 while being concentric with lens holder 3. Thus, since it is sufficient that lens holder 3 is not matched with the maximum external dimension of rear lens 22 but is matched with the size (dimension) of barrel inserting section 41, it is possible to entirely reduce the external dimension. That is, to the extent that the external dimension of barrel inserting section 41 is smaller than the maximum external dimension of rear lens 22, it is possible to reduce external dimension (reduce the diameter) of lens holder 3. Consequently, according to reduction of the external dimension of lens holder 3, it is possible to miniaturize imaging device 7 that accommodates lens barrel 1, or mobile terminal device 19 that accommodates imaging device 7.

Further, according to the present embodiment, lens barrel 1 includes lens pressing section 42 that is extended from barrel inserting section 41, is larger than the inner diameter of lens retaining section 32 and has the opposite face 42a in a position spaced from end surface 32a of lens retaining section 32. Thus, if barrel inserting section 41 of rear lens 22 is inserted in lens retaining section 32 when lens holder 3 and rear lens 22 are bonded and fixed to each other, the groove portion is formed between end surface 32a of lens retaining section 32 and lens pressing section 42 that is positioned in the opposite position spaced from end surface 32a of lens retaining section 32. Here, since first adhesive agent 5 is inserted in the groove portion, first adhesive agent 5 is hardly attached to the outer front surface of imaging lens 2 (lenses other than rear lens 22) that is accommodated inside lens holder 3 or rear lens 22 that is positioned closest to the imaging surface. Consequently, by preventing first adhesive agent 5 that bonds lens holder 3 and rear lens 22 from being attached to the front surface (surface through which incident light passes) of imaging lens 2, it is possible to suppress generation of ghost due to the front surface of the lens or reduction of resolution due to optical axis misalignment of the lens. Further, according to the present embodiment, among the plurality of lenses of imaging lens 2, the upper surface of the outer peripheral end portion of front lens 21 that is positioned closest to opening section 33 of lens holder 3 is in contact with the lower surface of lens supporting section 31 of lens holder 3. Further, the outer front surface of the lens in the central portion except for the outer peripheral end portion of front lens 21 is accommodated in lens holder 3 while maintaining the predetermined distance of exceeding 0 μm and 50 μm or less from the lower surface of lens holder 3. Thus, by preventing unnecessary light from the opening section that passes through a region outside the effective diameter of front lens 21 from being incident on image pickup device 10, it is possible to suppress generation of ghost.

Similarly, in imaging device 7 and mobile terminal device 19 that employ lens barrel 1 of the present embodiment, similarly, it is possible to suppress generation of ghost due to first adhesive agent 5 and reduction of resolution. Here, by using the adhesive agent of the ultraviolet light curing type as first adhesive agent 5, it is possible to perform curing for several seconds while the lens is fixed in a predetermined position by a jig or the like. As a result, it is possible to reduce working time for assembly of lens barrel 1 or the like and to enhance assembly accuracy of the lens. Further, by using an adhesive agent (for example, acrylic adhesive agent or the like) that is soft and low in hardness as the adhesive agent of the ultraviolet curing type, it is possible to reduce an influence that generates distortion or the like on the lens. On the other hand, if the hardness of the adhesive agent is excessively low, since the adhesive agent may be fractured by shock or the like, it is preferable to appropriately select an adhesive agent of an optimal hardness.

Further, according to the present embodiment, since lens pressing section 42 is pressed from the side of rear lens 22 to the side of lens holder 3 in the optical axis direction for bonding and fixing, the position accuracy of imaging lens 2 in the optical axis direction is enhanced. Further, since lens pressing section 42 of rear lens 22 is pressed toward the side of lens holder 3 by a mechanical method such as a jig, it is possible to prevent damage on the front surface of rear lens 22.

Further, according to the present embodiment, the spaced distance between end surface 32a of the lens holding section 32 in lens barrel 1 and opposite surface 42a of lens pressing section 42 is set in the range of 30 μm or more and 1 mm or less, and preferably, in the range of 50 μm or more and 500 μm or less. Thus, for example, in a case where the amount of first adhesive agent 5 is large, first adhesive agent 5 reaches the outside of the tip end portion of the outer surface of lens retaining section 32 to increase the bonding area. On the other hand, in a case where the amount of first adhesive agent 5 is small, the shape of first adhesive agent 5 at the opposite ends in the separating section is formed in a fillet shape. Thus, it is possible to enhance and stabilize the bonding strength of lens holder 3 and imaging lens 2, and to reduce the height of the lens barrel. The front surface of end surface 32a of lens retaining section 32, opposite surface 42a of lens pressing section 42 or the like to which first adhesive agent 5 is attached may be coarse. Thus, it is possible to increase the bonding area, to thereby enhance the bonding strength.

Further, according to the present embodiment, by sequentially increasing the respective diameters of lenses 2a to 2d toward the imaging surface, imaging lens 2 can contribute to miniaturization and wide angle of the imaging device or the like.

Further, according to the present embodiment, the outer peripheral surface of the tip end portion of lens retaining section 32 of lens holder 3 is formed in the taper shape. Thus, it is possible to suppress swelling of first adhesive agent 5 in the outer diameter direction of lens holder 3. Further, first adhesive agent 5 is easily inserted in the spaced portion between end surface 32a of the lens holding section 32 and opposite surface 42a of lens pressing section 42. Further, compared with the case of a straight shape, since the bonding area is increased by the taper shape, it is possible to enhance the bonding strength.

Further, according to the present embodiment, the inner peripheral surface of the tip end portion of lens retaining section 32 of lens holder 3 is formed in the R shape. Thus, first adhesive agent 5 that is interposed in the spaced portion between end surface 32a of lens holding section 32 and opposite surface 42a of lens pressing section 42 is inserted between the R shape of lens retaining section 32 of lens holder 3 and barrel inserting section 41. As a result, it is possible to increase the bonding area, to thereby enhance the bonding strength.

Further, according to the present embodiment, the plurality of slits, holes, concaves and convexes or the like are formed in the tip portion of lens retaining section 32 of lens holder 3. Thus, since first adhesive agent 5 fills the silts, the holes or the like of lens holder 3, it is possible to increase the bonding area with rear lens 22, to thereby enhance the bonding strength.

Further, according to the present embodiment, since imaging device 7 accommodates lens barrel 1 of the present embodiment, it is possible to obtain all the effects obtained by lens barrel 1. In addition, for example, since first adhesive agent 5 is inserted in the spaced portion between end surface 32a of lens holding section 32 and opposite surface 42a of lens pressing section 42 and it is possible to suppress swelling of first adhesive agent 5 in the outer diameter direction of lens holder 3, it is possible to prevent contact of the outer front surface of first adhesive agent 5 and a mechanical component opposite thereto. Further, for example, since the external dimension of lens holder 3 of lens barrel 1 is small, it is possible to reduce the size (downsize) of casing 9 of imaging device 7.

Further, according to the present embodiment, since mobile terminal device 19 includes imaging device 7 of the present embodiment, it is possible to obtain all the effects obtained by lens barrel 1 and imaging device 7. In addition, it is possible to realize miniaturization and weight saving of mobile terminal device 19.

The lens barrel, the imaging device and the mobile terminal device in the present invention are not limited to the above-described embodiment, and a variety of modifications may be made in a range without departing from the spirit of the invention.

That is, in the present embodiment, a configuration in which imaging lens 2 includes four lenses in lens barrel 1 has been described as an example, but the present invention is not limited thereto. For example, a configuration of two lenses may be employed.

Further, in the present embodiment, an example in which the part of the lens is cut (D cut or notch) has been described, but the cut may not be formed.

Further, in the present embodiment, an example in which lens holder 3 has male screw 34 that is screwed with female screw 81 on the side of imaging device 7 to be accommodated in imaging device 7 has been described, but the present invention is not limited thereto. For example, a configuration in which male screw 34 may not be formed in lens holder 3 may be used. Similarly, a configuration in which the taper shaped or plurality of slits, holes, concaves, convexes or the like are not formed in the tip end portion of lens retaining section 32 of lens holder 3, or a configuration in which the R shape is not formed on the inner peripheral surface of the tip end section of lens holding section 32 may be used.

Further, in the present embodiment, an example in which, when lens holder 3 and rear lens 22 are bonded to each other, rear lens 22 is pressed to lens holder 3 to insert barrel inserting section 41 of rear lens 22 in lens retaining section 32 of lens holder 3 for bonding and fixing has been described, but the present invention is not limited thereto. For example, after rear lens 22 is pressed to lens holder 3, rear lens 22 and lens holder 3 may be bonded and fixed to each other as rear lens 22 is attracted. Here, by forming a cut (D cut or notch) that is fit for the cut portion (D cut or notch) in the part of the lens in light shielding spacer (spacer) 6, it is possible to perform the bonding and fixing while attracting rear lens 22.

Further, in the present embodiment, an example in which the adhesive agent of the ultraviolet light curing type is used as first adhesive agent 5 has been described, but the present invention is not limited thereto. For example, an adhesive agent obtained by adding a component of being cured by heat, visible light, moisture, anaerobic conditions or the like to the adhesive agent of the ultraviolet light curing type may be used. Thus, even in a case where there is a location that is not irradiated by the ultraviolet light and is not cured, it is possible to complementarily cure the uncured location by applying heat or the like, to thereby completely cure the first adhesive agent.

### INDUSTRIAL APPLICABILITY

The present invention may be applied to a technical field such as a lens barrel, an imaging device and a mobile terminal device in which it is necessary to suppress generation of field curvature and reduction of resolution.

### Reference Marks in the Drawings

1 LENS BARREL
2 IMAGING LENS
2a, 2b, 2c, 2d LENS
3 LENS HOLDER
3a INNER WALL
4, 6d OUTER PERIPHERAL END PORTION
4a FLAT SURFACE SECTION
5 FIRST ADHESIVE AGENT
6a, 6b LIGHT SHIELDING SPACER
6c RESIN SPACER
7 IMAGING DEVICE
8 HOLDER
9 CASING
10 IMAGE PICKUP DEVICE
11 SUBSTRATE
12 GLASS PLATE
13 INFRARED LIGHT CUT FILTER
14 SUPPORTING SECTION
14a POSITIONING SECTION
14b PROTRUDING SECTION
14c LOWER PART
15 SECOND ADHESIVE AGENT
16 THIRD ADHESIVE AGENT
17 CONNECTING SECTION
18 COMMUNICATING SECTION
19 MOBILE TERMINAL DEVICE
20 MAIN CASE
20a, 20b PLATE BODY
21 FRONT LENS
22 REAR LENS
23 DISPLAY
24 OPERATING SECTION
31 LENS SUPPORTING SECTION
32 LENS RETAINING SECTION
32a END SURFACE
33 OPENING SECTION
34 MALE SCREW
41 BARREL INSERTING SECTION
42 LENS PRESSING SECTION
42a OPPOSITE SURFACE
81 FEMALE SCREW

1. A lens barrel comprising:
a lens holder;
an imaging lens that includes a plurality of lenses inserted in the lens holder, the plurality being at least three;
a light shielding spacer that is a light shielding plate disposed between the lenses; and
a resin spacer that is a light shielding plate disposed between the lenses which the light shielding spacer is not disposed and has a thickness in an optical axis direction thicker than that of the light shielding spacer, and has elasticity in the optical axis direction,
wherein the resin spacer is disposed between the lenses that affect field curvature, and
wherein the resin spacer is deformed and fixed in position by compressing a space between the lenses that affect the field curvature.

2. The lens barrel of claim 1,
wherein the bending elastic modulus of the resin spacer is 2000 MPa to 3000 MPa.

3. The lens barrel of claim 1,
wherein the resin spacer has a ring shape having a taper-shaped portion of which an inner wall diameter on the side of an image pickup device is larger than an inner wall diameter on the side of an object.

4. The lens barrel of claim 3,
wherein a gap is present between an outer peripheral end portion of the resin spacer on the side of the image pickup device and an inner wall of the lens holder.

5. The lens barrel of claim 3,
wherein the resin spacer is formed so that a minimum diameter of a portion which is in contact with a surface of the lens on the side of the image pickup device is larger than a maximum diameter of a portion which is in contact with a surface of the lens on the side of the object.

6. An imaging device comprising:
th lens barrel according to claim 1;
a holder that holds the lens barrel; and
an image pickup device that is disposed to have an imaging center corresponding to an optical axis of the lens barrel held by the holder.

7. A portable terminal apparatus comprising the imaging device of claim 6.
